(19) United States
(12) Patent Application Publication
(10) Pub. No.: US 2012/0320703 A1
(43) Pub. Date: Dec. 20, 2012

(54) HAND MIXER

(76) Inventor: Dilek Cumrali, Los Angeles, CA (US)

(21) Appl. No.: 13/160,161

(22) Filed: Jun. 14, 2011

(51) Int. Cl. A47J 43/27

(52) U.S. Cl. 366/130

(57) ABSTRACT

The invention relates to a device for mixing liquid mixtures, comprising a container having an opening, a cap having a bottom surface that can cover the opening of the container, and at least one protrusion protruding from the bottom surface of the cap.

### BACKGROUND AND FIELD OF ART

This invention relates to the field of mixing or blending liquid mixtures, such as foods or pharmaceuticals, omelet mixes, protein shakes, chocolate milk, powdered medicines dissolved in aqueous solutions, etc. Traditionally, mixing or blending such substances involved either the use of a utensil, such as a mixing stick, beater or spoon, to manually stir the mixture of elements until it is properly mixed, or an appliance such as a blender or food processor to accomplish the same. However stifling takes time and effort, and can lead to an uneven mixture. For example, when mixing a protein shake, clumps of protein powder may avoid the mixing utensil, and thereby not properly dissolve into the liquid with which it is being mixed. Similarly, appliances can produce a more consistent mixture, but require electricity or batteries to work and must generally be disassembled in order to clean.

Screw or hinge-top containers allow the mixing of such substances by hand-shaking the entire container. However, such containers do not have any interior structure to disrupt the flow of liquid through them, and the mixture obtained through such manual shaking may therefore be prone to inconsistency. More recently, as described in U.S. Pat. No. 6,379,032, companies have tried introducing independent structures as agitators to disrupt the flow of liquid while mixing in order to improve the consistency of the mixture. However such products are disadvantageous in that they require a separate structure to work, which increases costs, and places a burden on the consumer to not lose the separate structure.

### SUMMARY OF THE INVENTION

The invention overcomes the limitations of the prior art by introducing structure to disrupt flow of liquid through the bottle via one or more protrusions on the cap for a container or at the bottom of the container. The protrusions may be cylindrical, fluted or cross shaped or any combination thereof, and may be partially or completely tapered, or not. Additionally, the protrusions may optionally have a helical ridge along its outside to aid in the disruption of the flow of liquid during use.

### BRIEF DESCRIPTION OF THE DRAWINGS

FIG. 1 shows a perspective view an embodiment of the invention, with the cap of the container removed.

FIG. 2 shows a bottom view of the cap in an embodiment of the container.

FIGS. 3a, 3b, 3c an 3d show side and bottom views of different types of protrusions that may be used with the invention, wherein FIG. 3a shows a cylindrical protrusion, FIG. 3b shows a fluted protrusion, FIG. 3c. shows a cross-shaped protrusion, and FIG. 3d shows a cross-shaped protrusion comprising rectangles of alternating orientation.

FIGS. 4a and 4b show different types of protrusions that may be used with the invention. FIG. 4a shows a cylindrical protrusion with a helical ridge, and FIG. 4b shows a protrusion wherein the one end is cylindrical, with a helical ridge, and the opposite end is cross-shaped, without a helical ridge.

### DETAILED DESCRIPTION OF THE PREFERRED EMBODIMENTS

The invention is a hand-mixer for mixing liquid mixtures, such as foods or pharmaceuticals, omelet mixes, protein shakes, powdered medicines dissolved in aqueous solutions, and the like. Other uses contemplated for the invention include: (1) a batter mixer, for pancakes, crepes, waffles, etc., (2) an emulsifier for baby food, fish and shellfish batter mixer prior to frying, etc.; (3) a paint mixer, for example for mixing different paint colors, making a paint and glaze mixture, etc. The foregoing list of uses for the invention is meant to be regarded as illustrative rather than limiting, and it should be understood that the invention is intended to be used in making any sort of liquid mixture resulting from a combination a liquid with other liquids, powders, solids, etc.

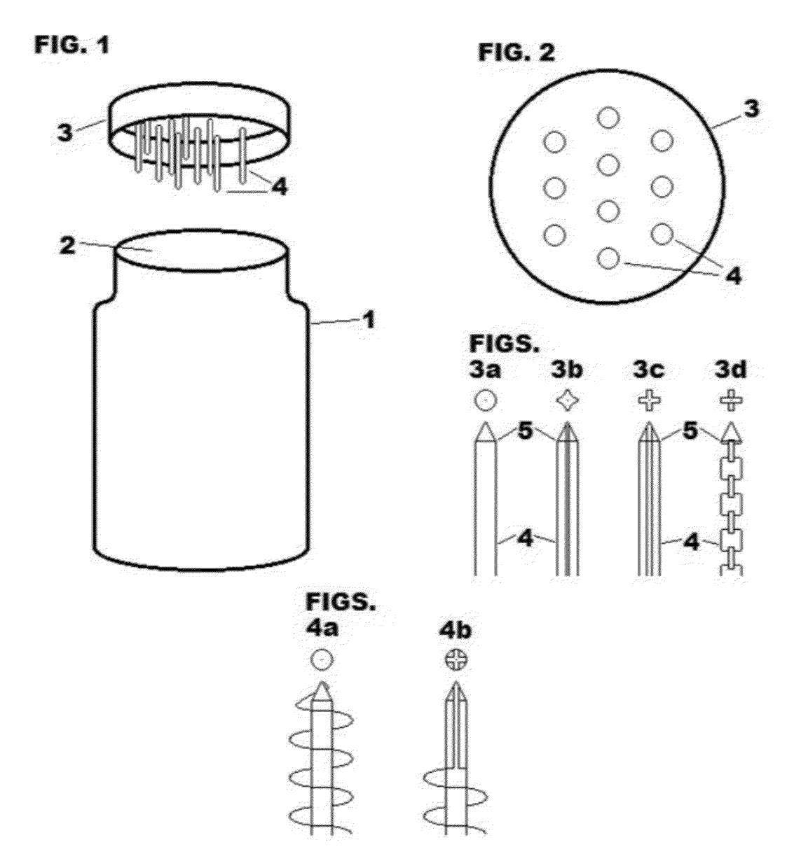

As shown in the exemplary embodiment in FIG. 1, the invention includes a container 1 which can be rigid or flexible, and can be made of plastic, glass, metal, wood, clay, rubber, or any other material or combination of materials known in the art. The container 1 has an opening 2, through which the substances to be mixed can be placed into the container 1. The invention further includes a cap 3, or lid, which covers the opening 2 of the container 1, such that the substances being mixed remain inside the container during mixing, and does not spill out. The cap 2, or lid, may be made of plastic, glass, metal, wood, clay, rubber or any other material or combination of materials know in the art. Optionally, rubber O-rings, or any similar structures known in the art may also be used to help seal the connection between the cap 3 and the container 1. The cap may attach to the container by screwing on (such as a screw and thread mechanism), by using a cam mechanism (such as an over-center cam mechanism), clipping on, form fitting attachment mechanism (such as a detent and groove mechanism), or any other form of attachment known to the art.

The invention further comprises at least one, and preferably more than one protrusion(s) 4. The protrusion(s) 4 are affixed to the interior surface of the cap 3, or lid, such that the protrusion(s) 4 extend into the container 1 when the cap 3, or lid, is attached. The protrusions 4 can be made of plastic, glass, metal, wood, clay, rubber, or any other suitable material or combination of materials known in the art. In such preferred embodiments, the protrusion(s) 4 may be separate structures that are attached to the lid through mechanical fasteners or through adhesion form-fitting connections, or other attachment methods known in the art. Where the protrusions 4 are separate structures, in certain embodiments, the protrusions 4 may be detachable (for example, for cleaning or so that the container can be used without the protrusions in the cap), such that they can be attached or removed as desired, and when they are connected they remain secured to the interior surface of the cap 3. In such embodiments the protrusions 4 may be secured to the cap by any means known in the art, including without limitation, clipping onto a retaining structure, sliding them into place, slide and lock mechanisms, detent and groove mechanisms, form fitting connections (e.g. dove tails), etc. The protrusions 4 may be attached/detached from the interior surface of the cap 3 individually, in groups, or all together as one piece. Alternatively the protrusion(s) 4 may be an integral part of the structure of the cap 3, or lid. For example, a mold for a molded plastic cap 3 may include the protrusion(s) 4 such that the cap 3 and the protrusion(s) 4 are formed of a single piece.

The protrusion(s) 4 may be arranged in any manner desired. For example, in embodiments with a single protrusion 4 on the cap 3, or lid, the protrusion 4 may be centered on the cap 4, or lid, or may be off-center. In embodiments with multiple protrusions 4, the protrusions 4 may be arranged in symmetric or asymmetric patterns. As shown in FIG. 2, they may be arranged in staggered rows, or they may be arranged in a grid pattern (not shown).

Similarly, the protrusions may have any desired shape. Examples of possible shapes are shown in FIGS. 3a, 3b and 3c. In FIG. 3a a cylindrical protrusion 4 is shown wherein the protrusion 4 is cylindrical from its base to a taper point 5, after which the cylindrical protrusion tapers in the shape of a cone. In FIG. 3b, the protrusion 4 is fluted, and likewise tapers after a tapering point 5. In FIG. 3c, the protrusion 4 is cross-shaped and tapered after a tapering point 5. FIG. 3d shows an alternative type of cross-shaped protrusion wherein the cross is formed by rectangular structures with alternating orientations. Optionally, cylindrical, fluted or cross-shaped protrusions 4 that do not taper may be used. Alternatively, protrusions 4 having other polygonal shapes, or other star-type shapes may be used. These examples are meant to be illustrative rather than limiting, as one of skill in the art will recognize that such protrusions 4 can take on a variety of shapes and sizes.

As shown in FIGS. 4a and 4b, the protrusions may optionally have a helical ridge 6, which extends around the sides of the protrusion, giving it a shape similar to that of a screw. As shown in FIG. 4a the helical ridge 6, may extend along the entire length of the protrusion. Alternatively, as shown in FIG. 4b, the helical ridge 6 may only extend along part of the protrusion 4. As also shown in 4b the shape of the protrusions need not be consistent along its length. The protrusion 4 shown in FIG. 4b is cylindrical with a helical ridge 6 at the bottom, and is cross-shaped without a helical ridge at the top. In an alternative embodiment, rings or discs may be used in place of the illustrated helical structure. Such structures assist in the mixing process by creating swirls and eddies, and by presenting irregular surfaces to a mixture being agitated, thereby enhancing the integration of substances being mixed.

The invention can be practiced with many sorts of containers. For example the container 1 may have a handle, grips, depressions for fingers, or may otherwise be shaped in any manner known in the art such that it is easier to hold while it is being shaken. In some embodiments, the container 1 may also have one or more additional openings, each having a corresponding cap, such that it is not necessary to remove the cap 3 having the protrusions 4 from the container 1 in order to extract the mixture within the container 1. Alternatively, in multiple-cap embodiments each cap 4 may have protrusions 3.

Persons of skill in the art will recognize that there are many implementation details and options left to the practitioner, but that would be within the scope of the current invention. It is intended that the foregoing detailed description be regarded as illustrative rather than limiting, and that it be understood that it is the following claims, including all equivalents, that are intended to define the spirit and scope of this invention.

I claim:

1. A mixing container comprising:
a container having an opening;
a cap having an inner surface adapted to fit over the opening to form a seal,
at least one protrusion extending inwardly from the interior surface of the cap.

2. The mixing container of claim 1 wherein the protrusions extending from the interior surface of the cap are integrally formed with the cap.

3. The mixing container of claim 1 wherein the at least one protrusion contains a helical ridge.

4. The mixing container of claim 1 wherein the at least one protrusion comprises a plurality of protrusions.

5. The mixing container of claim 4 wherein the protrusions are arranged in a grid pattern.

6. The mixing container of claim 4 wherein the protrusions are arranged in a staggered-row pattern.

7. The mixing container of claim 1 wherein at least one protrusion is cylindrical in shape.

8. The mixing container of claim 1 wherein at least one protrusion is fluted in shape.

9. The mixing container of claim 1 wherein at least one protrusion is cross-shaped.

10. The mixing container of claim 3 wherein the helical ridge extends along the entire length of at least one protrusion.

11. The mixing container of claim 4 wherein said protrusions further comprise one or more disks extending around said protrusions.

12. The mixing container of claim 1, said container and said cap further comprising a screw and thread closing mechanism.

13. The mixing container of claim 1, said container and said cap further comprising an over-center cam closing mechanism.

14. The mixing container of claim 1, said container and said cap further comprising an detent and groove mechanism.

15. The mixing container of claim 1, said container comprising a second closable opening.

16. The mixing container of claim 1, said container being rigid.

17. The mixing container of claim 1, said container being flexible.

18. The mixing container of claim 1 wherein the at least one protrusions can be attached and detached from the interior surface of the cap.

19. The mixing container of claim 4 wherein each of the plurality of protrusions can be attached to and detached from the interior surface of the cap individually.

20. The mixing container of claim 4 wherein the plurality of protrusions can be attached to and detached from the interior surface of the cap in at least one group of protrusions.
